(19) United States
(12) Patent Application Publication
(10) Pub. No.: US 2005/0207953 A1
(43) Pub. Date: Sep. 22, 2005

(54) High aspect ratio chemical microreactor

(75) Inventors: Ravindra S. Upadhye, Pleasanton, CA (US); Jeffrey D. Morse, Martinez, CA (US); David A. Sopchak, Livermore, CA (US); Mark A. Havstad, Davis, CA (US); Robert T. Graff, Modesto, CA (US)

Correspondence Address: Eddie E. Scott;Assistant Laboratory Counsel, Lawrence Livermore National Laboratory, P.O. Box 808, L-703, Livermore, CA, 94551, US

(73) Assignee: The Regents of the University of California

(21) Appl. No.: 10/896,413

(22) Filed: Jul. 20, 2004

Related U.S. Application Data
(60) Provisional application No. 60/489,323, filed on Jul. 22, 2003.

(51) Int. Cl. B01J 19/00

(52) U.S. Cl. 422/240; 422/129

(57) ABSTRACT

A chemical microreactor with a high aspect ratio. In one embodiment the chemical microreactor has a chemical microreactor section with channels having a height and with spacings having a width. There is a high aspect ratio of the height to the width. The high aspect ratio in one embodiment is more than substantially 5:1. The high aspect ratio in another embodiment is more than substantially 10:1. The high aspect ratio another embodiment is more than substantially 15:1. The high aspect ratio in one embodiment is substantially 20:1.

### CROSS-REFERENCE TO RELATED APPLICATIONS

This application claims the benefit of U.S. Provisional Patent Application No. 60/489,323 filed Jul. 22, 2003 and titled “Fully Integrated Chemical Microreactor and Method Thereof.” U.S. Provisional Patent Application No. 60/489,323 filed Jul. 22, 2003 and titled “Fully Integrated Chemical Microreactor and Method Thereof” is incorporated herein by this reference.

The United States Government has rights in this invention pursuant to Contract No. W-7405-ENG-48 between the United States Department of Energy and the University of California for the operation of Lawrence Livermore National Laboratory.

### BACKGROUND

1. Field of Endeavor

The present invention relates to chemical microreactors and more particularly to a high aspect ratio chemical microreactor.

2. State of Technology

U.S. Provisional Patent Application No. 2003/0039874 by Alan F. Jankowski and Jeffrey D. Morse published Feb. 27, 2003 and United States Provisional Patent Application No. 2003/0138685 by Alan F. Jankowski and Jeffrey D. Morse published Jul. 24, 2003 provides the following state of technology information, “Portable power sources of various types have been under development for many years. A serious need exists for portable power sources with significantly higher power density, longer operating lifetime, and lower cost. Present rechargeable and primary portable power sources have excessive weight, size, and cost with limited mission duration. As an example, batteries covering power range from 1-200 Watts have specific energies ranging from 50-250 Whr/Kg, which represents two to three hours of operation for a variety of commercial and military applications. An alternative power source is the fuel cell which would potentially provide higher performance power sources for portable power applications if the stack structure, packaging, and cell operation were made compatible with scaling down of size and weight. Fuel cells typically consist of electrolyte materials based on either polymer (proton exchange type) or solid oxide materials, which are sandwiched between electrodes. The fuel cell operates when fuel (usually hydrogen) is delivered to one electrode, and oxygen to the other. By heating the electrode-electrolyte structure, the fuel and oxidant diffuse to the electrode-electrolyte interfaces where an electrochemical reaction occurs, thereby releasing free electrons and ions which conduct across the electrolyte. Typical fuel cells are made from bulk electrode-electrolyte materials which are stacked and manifolded using stainless steel or other packaging which is difficult to miniaturize. These systems are bulky, requiring labor intensive manual assembly, packaging and testing, and in the case of solid oxide materials, typically operate at high temperatures (>600° C.). If the electrode-electrolyte stack can be made very thin and deposited using thin film deposition techniques, the temperature of operation will be significantly lower, and the cost of integration, packaging and manufacturing can be reduced.”

U.S. Pat. No. 6,607,857 to Richard H. Blunk et al for a fuel cell separator plate having controlled fiber orientation issued Aug. 19, 2003 provides the following state of technology information, “A composite separator plate for a fuel cell having a low-carbon loading and a high-polymer loading is disclosed. The separator plate composition includes a percentage of conductive fibrous filler having a relatively high aspect-ratio oriented through the thickness of the plate to achieve desired electrical and thermal conductivity requirements. A method of manufacturing the fuel separator plate having such fibers disposed in a through-plane orientation is also disclosed. The method includes forming a separator plate having a land height for orienting the fibers in a desired through-plane direction, then removing a portion of the land height to obtain the desired geometric configuration for the separator plate.”

### SUMMARY

Features and advantages of the present invention will become apparent from the following description. Applicants are providing this description, which includes drawings and examples of specific embodiments, to give a broad representation of the invention. Various changes and modifications within the spirit and scope of the invention will become apparent to those skilled in the art from this description and by practice of the invention. The scope of the invention is not intended to be limited to the particular forms disclosed and the invention covers all modifications, equivalents, and alternatives falling within the spirit and scope of the invention as defined by the claims.

The present invention provides a chemical microreactor having a high aspect ratio. In one embodiment the chemical microreactor of the present invention has a chemical microreactor section with channels having a height and with spacings having a width. There is a high aspect ratio of the height to the width. The high aspect ratio in one embodiment is more than substantially 5:1. The high aspect ratio in one embodiment is more than substantially 10:1. The high aspect ratio in one embodiment is more than substantially 15:1. The high aspect ratio in one embodiment is substantially 20:1.

In one embodiment the channels have a surface area and there is a volume in said channels and the channels have a high surface area to volume ratio. The surface area to volume ratio in one embodiment is more than substantially 5:1. The surface area to volume ratio in one embodiment is more than substantially 10:1. The surface area to volume ratio in one embodiment is more than substantially 15:1. The surface area to volume ratio in one embodiment is substantially 20:1.

The chemical microreactor is produced by forming the chemical microreactor section by anisotropic etching channels having a height and with spacings having a width, wherein there is a high aspect ratio said height to said width. The high aspect ratio in one embodiment is more than substantially 5:1. The high aspect ratio in one embodiment is more than substantially 10:1. The high aspect ratio in one embodiment is more than substantially 15:1. The high aspect ratio in one embodiment is substantially 20:1. In one embodiment, the step of forming a chemical microreactor section comprises etching channels in a silicon substrate using anisotropic etching and etch mask. In one embodiment the etching comprises etching channels in a silicon substrate using the Bosch process.

The invention is susceptible to modifications and alternative forms. Specific embodiments are shown by way of example. It is to be understood that the invention is not limited to the particular forms disclosed. The invention covers all modifications, equivalents, and alternatives falling within the spirit and scope of the invention as defined by the claims.

### BRIEF DESCRIPTION OF THE DRAWINGS

The accompanying drawings, which are incorporated into and constitute a part of the specification, illustrate specific embodiments of the invention and, together with the general description of the invention given above, and the detailed description of the specific embodiments, serve to explain the principles of the invention.

FIG. 1 is a top view of one embodiment of a chemical microreactor of the present invention.

FIG. 2 illustrates a system for producing a chemical microreactor.

FIG. 3 illustrates a system for producing a chemical microreactor.

FIG. 4 illustrates a system that integrates multiple separate chemical microreactors into a unitary system.

FIG. 5 another embodiment of the integration of chemical microreactors of the present invention is illustrated.

FIG. 6 another embodiment of the integration of chemical microreactors of the present invention is illustrated.

FIG. 7 another embodiment of the integration of chemical microreactors of the present invention is illustrated.

FIG. 8 another embodiment of the integration of chemical microreactors of the present invention is illustrated.

### DETAILED DESCRIPTION OF THE INVENTION

Referring to the drawings, to the following detailed description, and to incorporated materials, detailed information about the invention is provided including the description of specific embodiments. The detailed description serves to explain the principles of the invention. The invention is susceptible to modifications and alternative forms. The invention is not limited to the particular forms disclosed. The invention covers all modifications, equivalents, and alternatives falling within the spirit and scope of the invention as defined by the claims.

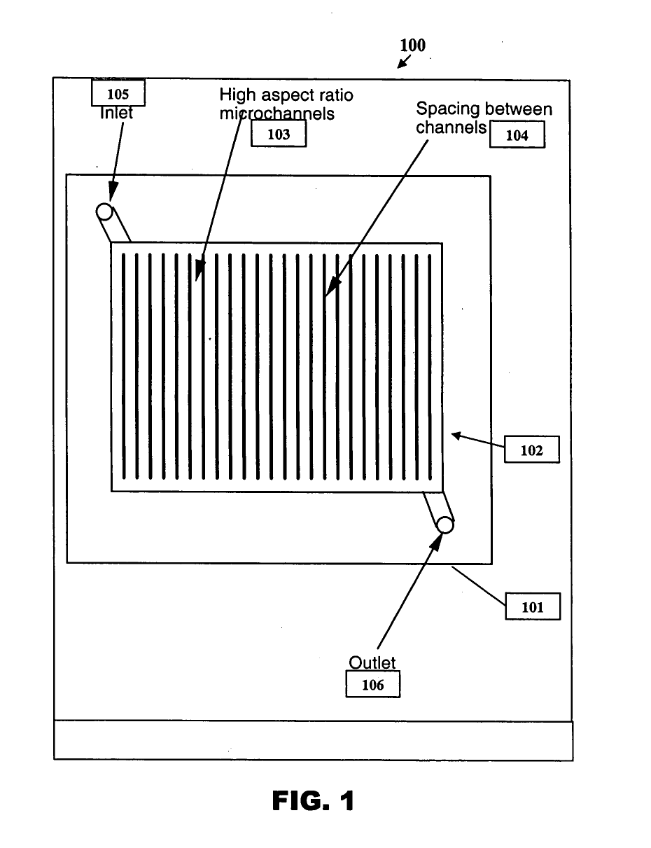

Referring now to FIG. 1, a top view of one embodiment of a chemical microreactor of the present invention is illustrated. Chemical microreactors have many uses. In addition to their efficiency, the chemical microreactors also offer the added benefit of being directly integrated into fuel cells powering electronic devices. A fuel cell system employing a chemical microreactor used to generate hydrogen for a fuel cell to power a laptop computer could be made 50% smaller than a conventional battery and be recharged instantly by replacing the spent fuel container. The efficiency of such fuel cells may also lend them to more esoteric applications in very small scale devices collectively referred to as micro-electrical-mechanical systems (MEMS). MEMS research typically entails the construction of electronic devices with moving parts smaller than the width of a human hair. MEMS have potential applications in fields as varied as communications and medicine, but the devices must first be equipped with efficient power supplies. “(MEMS) are all about energy and how efficiently you store it, and in that sense, microbattery technology is an excellent field of research.”

Chemical microreactors can be used to generate hydrogen for power sources that nominally operate from hydrogen fuel and air, which generate electrical power through a series of electrocatalytic reactions. For portable power applications, it is desirable to have a fuel source which is easy to carry and store, and has high energy density. Such fuel is found in liquid hydrocarbons, such as methanol, ethanol, butane, dimethyl-ether, or propanol. A miniature catalytic fuel processor is then required to convert the hydrocarbon fuel to hydrogen and other byproducts. In order to do so, an integrated chemical microreactor system is required which enables a catalyst bed to be heated, inlet fuel to be evaporated, and subsequent reaction volume and surface area sufficient to process the available reactants at high rates to achieve complete conversion.

The chemical microreactor embodiment shown in FIG. 1 is designated generally by the reference numeral 100. The chemical microreactor 100 includes a chemical microreactor section 101. The chemical microreactor section 101 includes a microchannel array 102 having channels and spacings. The microchannels are designated by the reference numeral 103 and the spacings are designated by the reference numeral 104. There is a high aspect ratio of the height to the width. The high aspect ratio of the height to the width of the microchannels 103 is substantially 20:1. The microchannels 103 have a surface area and there is a volume in said channels and the channels have a high surface area to volume ratio. The surface area to volume ratio is more than substantially 5:1. The surface area to volume ratio of the microchannels 103 is substantially 20:1.

An inlet 105 and an outlet 106 are connected to the chemical microreactor section 101. The inlet 105 and the outlet 106 are arranged in symmetrical layout, therefore each flow path has an equivalent pressure drop. The length of the microchannels 103 can be many centimeters, and the limitation is the required pressure drop of the entire array from inlet to outlet. Various embodiments of the present invention provide pressure drops on the order of <1-2 pounds per square inch, sufficient to be controlled by microscale pumps. The microchannel arrays may be arranged or patterned in any of several layouts between the inlet and outlet. While FIG. 1 illustrates an array of straight channels 103, the channels 103 can also be laid out in a serpentine or zig-zag pattern in order to provide some turbulence or mixing of the reactants as they flow along the channels, thereby increasing the interaction with the catalyst coated on the sidewalls.

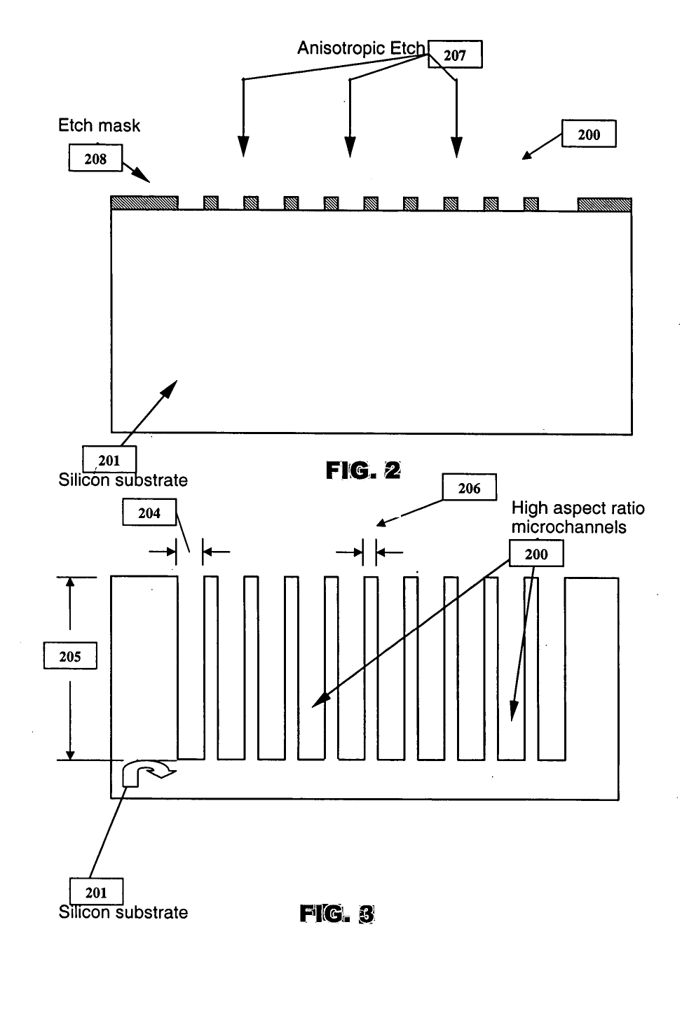

Referring now to FIG. 2 and FIG. 3, a system is illustrated for producing the chemical microreactor 100 shown in FIG. 1. A high aspect ratio microchannel array 200 is formed in a silicon substrate 201 using anisotropic etching 207 and etch mask 208. The anisotropic etching techniques include wet etching with potassium hydroxide or dry plasma etching using the Bosch process. The latter enables aspect ratios of substantially 20:1 to be formed in the silicon substrate 201. The width 204 of the microchannels 203 in the array 200 may be as small as 5 μm, but more typically the 25 μm to 200 μm range is optimal, with channel depths 205 ranging to a factor twenty times the width 204. The spacing 206 between the channels 203 can be as small as 5-10 microns, but 25 μm is more typical for the very deep channels.

While standard silicon wafers are 500 microns thick, thicker substrates of 1-2 mm can be used to provide the deeper microchannel etches. After etching the microchannels 203 in the silicon 201, a wafer bonding step is conducted to form sealed microchannels having an inlet at one end and an outlet at the other end. Anodic, fusion, adhesive, or chemical bonding of the substrates can be used. For miniature chemical microreactor power sources, fuel flows in the range from 5 microliters/min to 600 microliters/min provide output electrical powers ranging from 300 milliwatts to >40 Watts. In order to effectively process the fuel in as compact and lightweight a device as possible, high aspect ratio (height to width) microchannel array networks are used.

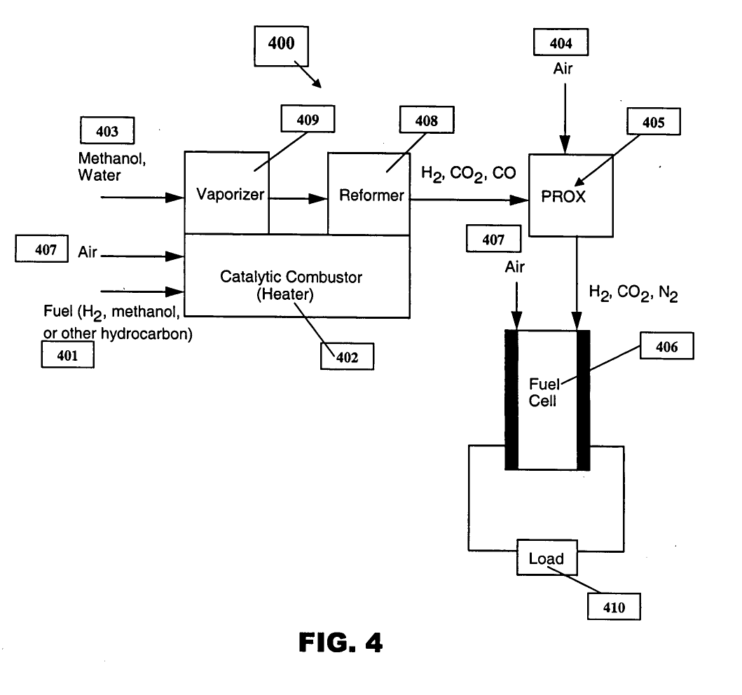

Referring now to FIG. 4, a system that integrates a number of chemical microreactors into a unitary system is illustrated. The overall system is designated generally by the reference numeral 400. In the system 400, chemical microreactors are used in the catalytic combustor 402, in the reformer 408, in the PROX 405, and in the vaporizer 409. The system 400 is a microelectromechanical system (MEMS) and micromachining fabrication techniques are utilized to form intricate three-dimensional fluidic structures within a microchip substrate.

The catalytic combustor 402 provides a heating system for the vaporizer 409 and the reformer 408. In the heating system a liquid hydrocarbon fuel 401 is vaporized after which it flows through a catalyst bed 402 that is heated to a nominal reaction temperature. Air 407 flows into the catalyst bed of the catalytic combustor 402. A chemical microreactor section is part of the catalytic combustor 402. The chemical microreactor section includes channels having a height and with spacings having a width. There is a high aspect ratio of the height to the width. The high aspect ratio in one embodiment is more than substantially 5:1. The high aspect ratio in one embodiment is more than substantially 10:1. The high aspect ratio in one embodiment is more than substantially 15:1. The high aspect ratio in one embodiment is substantially 20:1.

Referring again to FIG. 4, methanol mixed with water 403 is vaporized in vaporizer 409 and directed into a reformer 408. Methanol mixed with water is used as an example, although the other liquid hydrocarbon fuels can be substituted. The catalyst is a combination reforming and shift catalyst, which provides the general reaction for methanol
CH₃OH+H₂O [symbol] 3H₂+CO₂

The optimal reforming and shift catalyst for methanol steam reforming is Copper-Zinc Oxide supported on alumina, and several versions are commercially available.

A chemical microreactor section is part of the reformer 408. The chemical microreactor section includes channels having a height and with spacings having a width. There is a high aspect ratio of the height to the width. The high aspect ratio in one embodiment is more than substantially 5:1. The high aspect ratio in one embodiment is more than substantially 10:1. The high aspect ratio in one embodiment is more than substantially 15:1. The high aspect ratio in one embodiment is substantially 20:1.

Since the reaction described above can generate small quantities of carbon monoxide which can poison the anode catalyst of proton exchange membrane chemical microreactors, a preferential oxidation reaction, PROX 405 is typically used after the reforming and shift reactions to further reduce the levels of carbon monoxide in the fuel feed to levels which are tolerable to the chemical microreactor anode catalyst. This reaction combines the fuel feed with an air 404 or oxygen stream in which the ratio of oxygen to carbon monoxide molecules in the fuel stream is between about 1 and about 2.

The catalyst, which may consist of Ruthenium, Iridium, platinum, cobalt, tin, or combinations or oxides thereof on a high surface area alumina support, is heated to a nominal temperature at which the carbon monoxide is selectively oxidized to carbon dioxide without reacting hydrogen at any significant levels. The preferential oxidation (PROX) reaction 405 is typically somewhat exothermic, thus will self heat once reactions are initiated.

The optimal temperature to selectively remove the carbon monoxide from the fuel stream is typically much lower than the reforming temperature, for example, 70-140° C. for a Ruthenium based PROX catalyst, versus 250-300° C. for a Copper-Zinc Oxide based reforming catalyst. Typically, carbon monoxide levels on the order of 1% in the fuel feed can be reduced to levels less than 100 parts per million (0.01%).

For fuel processors, thermal balance of the system is a critical design issue. The reforming catalyst bed must be heated up and maintained at an operating temperature of 250-300° C. for steam reforming of methanol, although depending on the catalyst and fuel, this temperature may be higher, up to 400° C. for methanol, and 650° C. for butane, propane, or methane. The incoming fuel stream must be evaporated and heated to the operating temperature, the exhaust stream of processed fuel must be cooled to minimize loss of heat prior to being mixed with the air stream 404 in the PROX reactor 405, and the incoming air stream 404 must be preheated so it doesn't cool the reactant gases in the PROX reactor 405.

A chemical microreactor section is part of the PROX reactor 405. The chemical microreactor section includes channels having a height and with spacings having a width. There is a high aspect ratio of the height to the width. The high aspect ratio in one embodiment is more than substantially 5:1. The high aspect ratio in one embodiment is more than substantially 10:1. The high aspect ratio in one embodiment is more than substantially 15:1. The high aspect ratio in one embodiment is substantially 20:1.

The output of the PROX reactor 405 is directed into a fuel cell 406. Air 407 is also directed into the fuel cell. Power is produce by the fuel cell 406 and the power can be used by the load 410.

In summary of the system 400 shown in FIG. 4, while some form of electrical heating may be satisfactory for electrical startup, this is inefficient for long term heating of the catalyst bed. Typical means for heating the reformer bed uses a catalytic combustor which combines fuel (hydrogen or hydrocarbon) with air as it passes over a separate catalyst bed. The catalyst is typically a platinum or platinum on alumina support. When the oxygen and hydrogen pass over the catalyst, the catalytic reaction is exothermic, therefore is a very efficient source of heat. The combustor catalyst bed is in thermal communication with the reformer and the incoming fuel stream, thereby provides the necessary heat of reaction for reforming.

Additionally, the heat generated by the combustor can be controlled by controlling or balancing the flows of either air or fuel, or both, flowing into the combustor. Heat exchangers are used to preheat the air and fuel reactant streams in order to efficiently balance the thermal management of the system. Additional use of thermal insulation is incorporated as necessary depending on the amount of heat loss for the system.

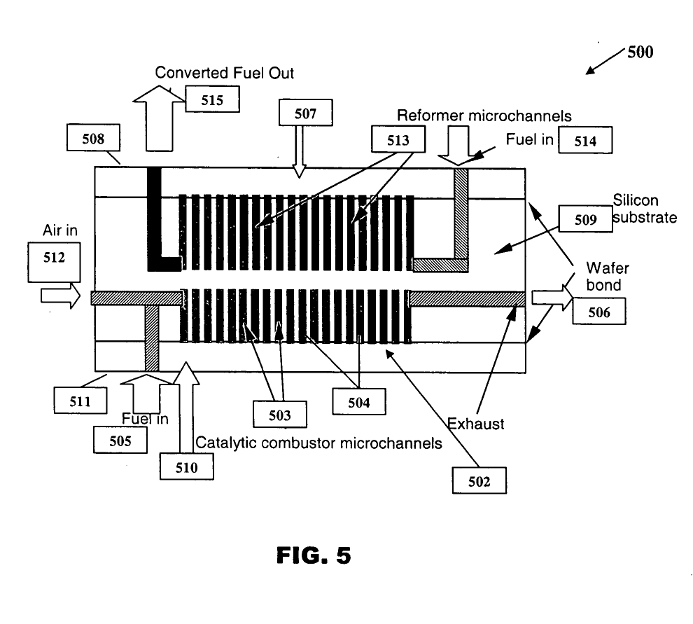

Referring now to FIG. 5, another embodiment of a chemical microreactor of the present invention is illustrated. This embodiment is designated generally by the reference numeral 500. The system 500 is a microelectromechanical system (MEMS) and micromachining fabrication techniques are utilized to form intricate three-dimensional fluidic structures within a microchip substrate 509.

In the system 500, a reformer 507 is formed in the topside 508 of a silicon substrate 509, and a catalytic combustor 510 is formed in bottom 511 of the same substrate 509. This is achieved by first patterning and etching the top side 508, then patterning and etching the bottom 511. The etch depths into the silicon substrate 509 are controlled such that the distance remaining between the two arrays of microchannels on each side of the substrate 509 are on the order of 50-250 μm. This provides efficient thermal coupling between the catalytic combustor 510 heat source and the reformer 507, which is endothermic. Wafer bonding is used to form the enclosed microchannel arrays with independent inlet and outlet vias. The reformer 507 includes a microchannel array 513. Fuel is introduced to the reformer 507 through inlet 514 and the converted fuel emerges through outlet 515.

The combustor 510 includes a microchannel array 502 having channels with a height and spacings with a width. The channels are designated by the reference numeral 503 and the spacings are designated by the reference numeral 504. There is a high aspect ratio of the height to the width. The high aspect ratio is in the range of between substantially 12:1 to substantially 20:1. The channels 503 have a surface area and there is a volume in said channels. The channels have a high surface area to volume ratio.

The chemical microreactor section 510 includes a fuel inlet 505, an air inlet 512, and an exhaust outlet 506. The length of the microchannels 503 can be many centimeters, and the limitation is the required pressure drop of the entire array from inlet to outlet. Various embodiments of the present invention provide pressure drops on the order of <1-2 pounds per square inch, sufficient to be controlled by microscale pumps. The microchannel arrays may be arranged or patterned in any of several layouts between the inlet and outlet. While FIG. 5 illustrates an array of straight channels 503, the channels 503 can also be laid out in a serpentine or zig-zag pattern in order to provide some turbulence or mixing of the reactants as they flow along the channels, thereby increasing the interaction with the catalyst coated on the sidewalls.

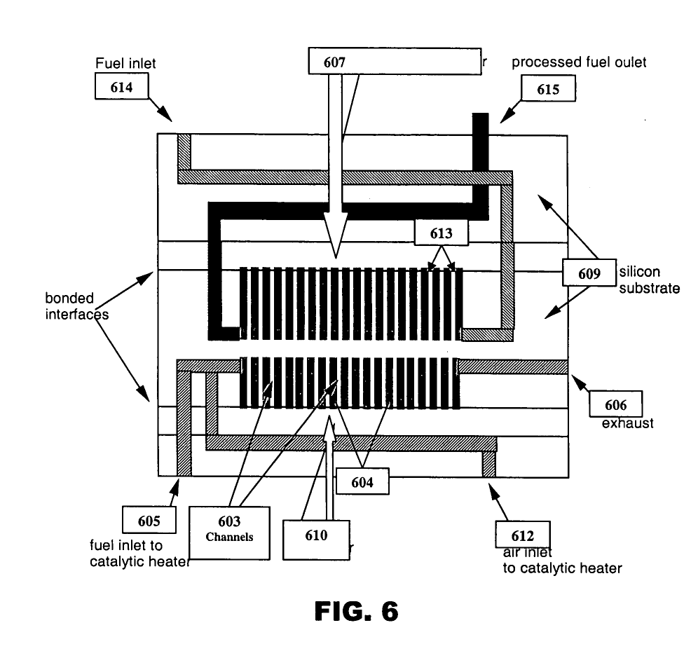

Referring now to FIG. 6, another embodiment of a chemical microreactor of the present invention is illustrated. This embodiment is designated generally by the reference numeral 600. In the embodiment 600, additional layers are added which provide vaporization of the incoming fuel mixture and preheating of the incoming air and fuel reactants for the catalytic microcombustor in order to minimize heat losses, rendering the system very efficient. Additional thermal insulation can be added to minimize any further heat losses to the surrounding package or environment, and materials such as aerogels, Kapton foam, or porous ceramics having very low thermal conduction values can be incorporated.

In the embodiment 600, a reformer 607 is formed in a silicon substrate 609. A catalytic combustor 610 is formed in the same substrate 609. This is achieved by first patterning and etching the top side, then patterning and etching the bottom of substrate 609. The etch depths into the silicon substrate 609 are controlled such that the distance remaining between the two arrays of microchannels on each side of the substrate 609 are on the order of 50-250 μm. This provides efficient thermal coupling between the catalytic combustor 610 heat source and the reformer 607, which is endothermic. Wafer bonding is used to form the enclosed microchannel arrays with independent inlet and outlet vias. The reformer 607 includes a microchannel array 613. Fuel is introduced to the reformer 607 through inlet 614 and the converted fuel emerges through outlet 615.

The combustor 610 includes a microchannel array 602 having channels with a height and spacings with a width. The channels are designated by the reference numeral 603 and the spacings are designated by the reference numeral 604. There is a high aspect ratio of the height to the width. The high aspect ratio is in the range of between substantially 12:1 to substantially 20:1. The channels 603 have a surface area and there is a volume in said channels. The channels have a high surface area to volume ratio.

The chemical microreactor section 610 includes a fuel inlet 605, an air inlet 612, and an exhaust outlet 606. The length of the microchannels 603 can be many centimeters, and the limitation is the required pressure drop of the entire array from inlet to outlet. Various embodiments of the present invention provide pressure drops on the order of <1-2 pounds per square inch, sufficient to be controlled by microscale pumps. The microchannel arrays may be arranged or patterned in any of several layouts between the inlet and outlet. While FIG. 6 illustrates an array of straight channels 603, the channels 603 can also be laid out in a serpentine or zig-zag pattern in order to provide some turbulence or mixing of the reactants as they flow along the channels, thereby increasing the interaction with the catalyst coated on the sidewalls.

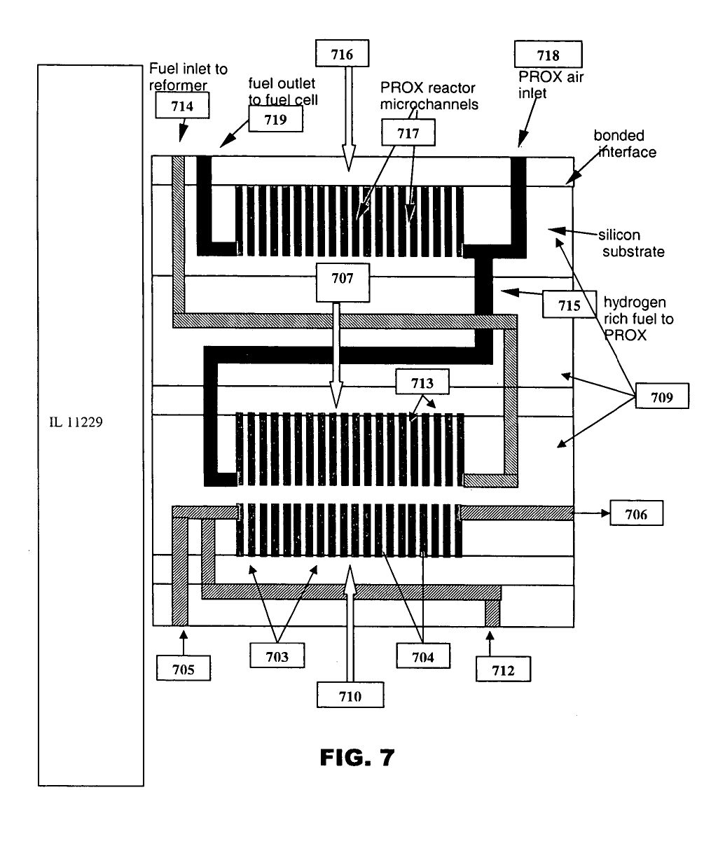

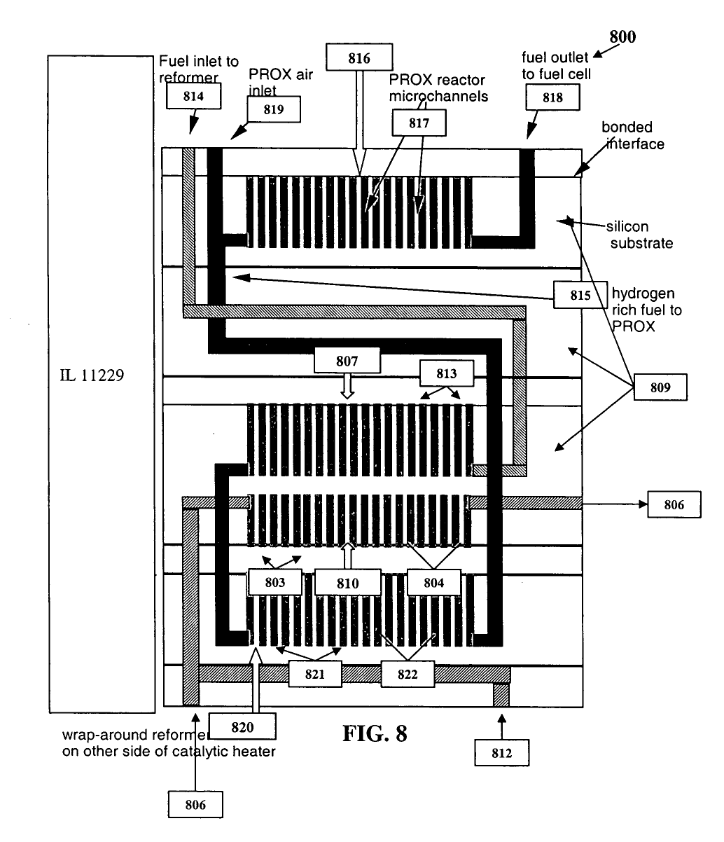

Referring now to FIG. 7, yet another embodiment of a chemical microreactor of the present invention is illustrated. This embodiment is designated generally by the reference numeral 700. In the embodiment 700, a PROX reactor 716 is formed the same way as previously described for the device in FIGS. 5 and 6. The PROX reactor 716 is positioned at the outlet 715 of the reformer 707 microchannels.

In the embodiment 700, a reformer 707 is formed in a silicon substrate 709. A catalytic combustor 710 is formed in the same substrate 709. This is achieved by first patterning and etching the top side, then patterning and etching the bottom of substrate 709. The etch depths into the silicon substrate 709 are controlled such that the distance remaining between the two arrays of microchannels on each side of the substrate 709 are on the order of 50-250 μm. This provides efficient thermal coupling between the catalytic combustor 710 heat source and the reformer 707, which is endothermic. Wafer bonding is used to form the enclosed microchannel arrays with independent inlet and outlet vias. The reformer 707 includes a microchannel array 713. Fuel is introduced to the reformer 707 through inlet 714 and the converted fuel emerges through outlet 715.

The combustor 710 includes a microchannel array 702 having channels with a height and spacings with a width. The channels are designated by the reference numeral 703 and the spacings are designated by the reference numeral 704. There is a high aspect ratio of the height to the width. The high aspect ratio is in the range of between substantially 12:1 to substantially 20:1. The channels 703 have a surface area and there is a volume in said channels. The channels have a high surface area to volume ratio.

The chemical microreactor section 710 includes a fuel inlet 705, an air inlet 712, and an exhaust outlet 706. The length of the microchannels 703 can be many centimeters, and the limitation is the required pressure drop of the entire array from inlet to outlet. Various embodiments of the present invention provide pressure drops on the order of <1-2 pounds per square inch, sufficient to be controlled by microscale pumps. The microchannel arrays may be arranged or patterned in any of several layouts between the inlet and outlet. While FIG. 7 illustrates an array of straight channels 703, the channels 703 can also be laid out in a serpentine or zig-zag pattern in order to provide some turbulence or mixing of the reactants as they flow along the channels, thereby increasing the interaction with the catalyst coated on the sidewalls.

In the embodiment 700, the PROX microreactor 716 is placed above the vaporizer section, and possibly with some additional thermal insulation such that a temperature gradient is achieved in order to maintain the PROX reactor catalyst at its optimal operating temperature. If the PROX catalyst performs sufficiently at the reformer operating temperature, as in the case of some Iridium based catalysts, then this temperature drop is not necessary. Additional preheating of the PROX reactor air stream can be achieved through the vaporizor or similar counterflow heat exchange stages, thereby optimal thermal management and efficiency of the integrated system can be achieved. Additional layers are added which provide vaporization of the incoming fuel mixture and preheating of the incoming air and fuel reactants for the catalytic microcombustor in order to minimize heat losses, rendering the system very efficient. Additional thermal insulation can be added to minimize any further heat losses to the surrounding package or environment, and materials such as aerogels, Kapton foam, or porous ceramics having very low thermal conduction values can be incorporated.

Referring now to FIG. 8, another embodiment of a chemical microreactor of the present invention is illustrated. This embodiment is designated generally by the reference numeral 800. In the embodiment 800, a PROX reactor 816 is formed the same way as previously described for the reformer device in FIGS. 5 and 6. The PROX reactor 816 is positioned at the outlet 815 of the reformer 807 microchannels. In the embodiment 800, the fuel reformer section 820 is wrapped around the catalytic heater section 810, thereby increasing the volume of the reformer catalyst bed.

In the embodiment 800, a reformer 807 is formed in a silicon substrate 809. A catalytic combustor 810 is formed in the same substrate 809. This is achieved by first patterning and etching the top side, then patterning and etching the bottom of substrate 809. The etch depths into the silicon substrate 809 are controlled such that the distance remaining between the two arrays of microchannels on each side of the substrate 809 are on the order of 50-250 μm. This provides efficient thermal coupling between the catalytic combustor 810 heat source and the reformer 807, which is endothermic. Wafer bonding is used to form the enclosed microchannel arrays with independent inlet and outlet vias. The reformer 807 includes a microchannel array 813. Fuel is introduced to the reformer 807 through inlet 814 and the converted fuel emerges through outlet 815.

The combustor 810 includes a microchannel array 802 having channels with a height and spacings with a width. The channels are designated by the reference numeral 803 and the spacings are designated by the reference numeral 804. There is a high aspect ratio of the height to the width. The high aspect ratio is in the range of between substantially 12:1 to substantially 20:1. The channels 803 have a surface area and there is a volume in said channels. The channels have a high surface area to volume ratio.

The chemical microreactor section 810 includes a fuel inlet 805, an air inlet 812, and an exhaust outlet 806. The length of the microchannels 803 can be many centimeters, and the limitation is the required pressure drop of the entire array from inlet to outlet. Various embodiments of the present invention provide pressure drops on the order of <1-2 pounds per square inch, sufficient to be controlled by microscale pumps. The microchannel arrays may be arranged or patterned in any of several layouts between the inlet and outlet. While FIG. 8 illustrates an array of straight channels 803, the channels 803 can also be laid out in a serpentine or zig-zag pattern in order to provide some turbulence or mixing of the reactants as they flow along the channels, thereby increasing the interaction with the catalyst coated on the sidewalls.

In the embodiment 800, the PROX microreactor 816 is placed above the vaporizer section, and possibly with some additional thermal insulation such that a temperature gradient is achieved in order to maintain the PROX reactor catalyst at its optimal operating temperature. If the PROX catalyst performs sufficiently at the reformer operating temperature, as in the case of some Iridium based catalysts, then this temperature drop is not necessary. Additional preheating of the PROX reactor air stream can be achieved through the vaporizer or similar counterflow heat exchange stages, thereby optimal thermal management and efficiency of the integrated system can be achieved. Additional layers are added which provide vaporization of the incoming fuel mixture and preheating of the incoming air and fuel reactants for the catalytic microcombustor in order to minimize heat losses, rendering the system very efficient. Additional thermal insulation can be added to minimize any further heat losses to the surrounding package or environment, and materials such as aerogels, Kapton foam, or porous ceramics having very low thermal conduction values can be incorporated.

Referring now to FIGS. 1-8, a fully integrated chemical microreactor system has been described that provides high surface area, high surface to volume ratio, and precise thermal and chemical control of reactions for converting hydrocarbon fuel to a hydrogen rich gas feed to a fuel cell. In the case of proton exchange membrane fuel cells wherein the anode catalyst may be intolerant to CO present in the fuel feed, a preferential oxidation microreactor is integrated with the fuel processor which eliminates CO without significantly reducing the amount of hydrogen in the fuel feed. The integrated chemical microreactor further employs a catalytic heating device to provide the heat of reaction for the fuel reformer. Further system optimization with integration of heat exchangers and vaporizers render this fuel processor very efficient.

The present invention provides a high surface area, high surface-to-volume ratio microfluidic structure to form a highly integrated fuel processor system. In doing so microelectromechanical system (MEMS) and micromachining fabrication techniques and designs are utilized to form intricate three-dimensional fluidic structures within a microchip substrate. The advantages of using silicon substrates include well developed processes for micromachining, ability to form high aspect ratio flow structures, control of thermal conductivity, and surface sealing through wafer bonding processes.

Additionally, processes to coat the microchannels sidewalls with catalyst materials are readily available through vacuum deposition, electrodeposition, solgel, washcoat, ion exchange, or doping methods enabling control of chemistry, porosity, and surface area of the catalyst coating. In addition, it is further the intent of this invention to provide optimal catalyst coatings on the microchannel sidewalls and peripheries, and that the dimensions of the microchannels are such that the fuel reactants are efficiently reacted in as small a volume and as short a flow path as possible.

The section between the outlet and the microchannel array can incorporate some form of a catalyst embedded porous membrane or catalyst particles that fill the microchannel transition region, thereby providing a small amount or backpressure and tortuous flow path for reactants prior to exiting the microchannel array catalyst bed. This will further improve reactant conversion efficiency by increasing the residence time of the reactants in the catalyst bed. This concept can be applied to reformer, catalytic combustor, and PROX reactor segments of the integrated fuel processing system.

In forming the microchannel arrays for the reformer, or catalytic combustor for that matter, the catalyst can be coated onto the sidewalls of the microchannels prior to bonding through techniques such as physical vapor deposition, or can be disposed on all of the microchannel walls after wafer bonding using techniques such as electrodeposition, solgel, or washcoat. The latter two are especially effective in that precise stoichiometries of catalyst with support materials such as alumina can be formed having very high surface area and porosity, thereby efficiently exposing the catalyst to the reactants that flow through the channels. Nominal catalysts for methanol reforming include CuZnO on alumina, while combustor catalysts are typically platinum on alumina. For other fuels, such as butane or propanol, other catalyst may be used, including platinum, nickel, ruthenium, ceria, titanium, tin, molybdenum, vanadium, or combinations thereof, oxides thereof, and supported on alumina if necessary.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A chemical microreactor apparatus, comprising:
a microreactor section that has
channels and
spacings, wherein
said channels have a height and
said spacings have a width and wherein there is
a high aspect ratio of said height to said width.

2. The chemical microreactor apparatus of claim 1 wherein said high aspect ratio is more than substantially 5:1.

3. The chemical microreactor apparatus of claim 1 wherein said high aspect ratio is more than substantially 10:1.

4. The chemical microreactor apparatus of claim 1 wherein said high aspect ratio is more than substantially 15:1.

5. The chemical microreactor apparatus of claim 1 wherein said high aspect ratio is substantially 20:1.

6. The chemical microreactor apparatus of claim 1 wherein said high aspect ratio is less than substantially 100:1 and more than substantially 5:1.

7. The chemical microreactor apparatus of claim 1 wherein said high aspect ratio is less than substantially 50:1 and more than substantially 5:1.

8. The chemical microreactor apparatus of claim 1 wherein said high aspect ratio is less than substantially 25:1 and more than substantially 5:1.

9. The chemical microreactor apparatus of claim 1 wherein said high aspect ratio is less than substantially 100:1 and more than substantially 15:1.

10. The chemical microreactor apparatus of claim 1 wherein said high aspect ratio is less than substantially 50:1 and more than substantially 15:1.

11. The chemical microreactor apparatus of claim 1 wherein said high aspect ratio is less than substantially 25:1 and more than substantially 15:1.

12. The chemical microreactor apparatus of claim 1 wherein said width is in the range of 5 μm to 200 μm.

13. The chemical microreactor apparatus of claim 1 wherein said width is in the range of 5 μm to 200 μm and said height is in the range of 250 μm to 4000 μm.

14. The chemical microreactor apparatus of claim 1 wherein said channels have a surface area and there is a volume in said channels and wherein said channels have a high surface area to volume ratio.

15. The chemical microreactor apparatus of claim 1 wherein said channels are straight channels.

16. The chemical microreactor apparatus of claim 1 wherein said channels are serpentine channels.

17. The chemical microreactor apparatus of claim 1 wherein said channels are zig-zag pattern channels.

18. The chemical microreactor apparatus of claim 1 wherein said channels are located in a silicon substrate.

19. A chemical microreactor apparatus, comprising:
a substrate,
at least one chemical microreactor section formed in said substrate, said at least one chemical microreactor including
channels having a height and
spacings having a width and
wherein there is a high aspect ratio of said height to said width.

20. The chemical microreactor apparatus of claim 1 wherein said substrate is a silicone substrate.

21. The chemical microreactor apparatus of claim 19 wherein said high aspect ratio is more than substantially 5:1.

22. The chemical microreactor apparatus of claim 19 wherein said high aspect ratio is more than substantially 10:1.

23. The chemical microreactor apparatus of claim 19 wherein said high aspect ratio is more than substantially 15:1.

24. The chemical microreactor apparatus of claim 19 wherein said high aspect ratio is substantially 20:1.

25. The chemical microreactor apparatus of claim 19 wherein said high aspect ratio is less than substantially 100:1 and more than substantially 5:1.

26. The chemical microreactor apparatus of claim 19 wherein said high aspect ratio is less than substantially 50:1 and more than substantially 5:1.

27. The chemical microreactor apparatus of claim 19 wherein said high aspect ratio is less than substantially 25:1 and more than substantially 5:1.

28. The chemical microreactor apparatus of claim 19 wherein said high aspect ratio is less than substantially 100:1 and more than substantially 15:1.

29. The chemical microreactor apparatus of claim 19 wherein said high aspect ratio is less than substantially 50:1 and more than substantially 15:1.

30. The chemical microreactor apparatus of claim 19 wherein said high aspect ratio is less than substantially 25:1 and more than substantially 15:1.

31. The chemical microreactor apparatus of claim 19 wherein said width is in the range of 5 μm to 200 μm.

32. The chemical microreactor apparatus of claim 19 wherein said width is in the range of 5 μm to 200 μm and said height is in the range of 250 μm to 4000 μm.

33. The chemical microreactor apparatus of claim 19 wherein said channels have a surface area and there is a volume in said channels and wherein said channels have a high surface area to volume ratio.

34. The chemical microreactor apparatus of claim 19 wherein said channels are straight channels.

35. The chemical microreactor apparatus of claim 19 wherein said channels are serpentine channels.

36. The chemical microreactor apparatus of claim 19 wherein said channels are zig-zag pattern channels.

37. A method of producing a chemical microreactor comprising the steps of:
forming a chemical microreactor section by anisotropic etching channels having a height and with spacings having a width,
wherein there is a high aspect ratio said height to said width.

38. The method of claim 37 wherein said step of forming a chemical microreactor section comprises etching channels in a silicon substrate using anisotropic etching and etch mask.

39. The method of claim 37 wherein said step of forming a chemical microreactor section comprises etching channels in a silicon substrate using the Bosch process.

40. The method of claim 37 wherein said step of forming a chemical microreactor section comprises etching channels in a silicon substrate using wet etching with potassium hydroxide or dry plasma etching using the Bosch process.

41. The chemical microreactor apparatus of claim 37 wherein said high aspect ratio is more than substantially 5:1.

42. The chemical microreactor apparatus of claim 37 wherein said high aspect ratio is more than substantially 10:1.

43. The chemical microreactor apparatus of claim 37 wherein said high aspect ratio is more than substantially 15:1.

44. The chemical microreactor apparatus of claim 37 wherein said high aspect ratio is substantially 20:1.

45. The chemical microreactor apparatus of claim 37 wherein said high aspect ratio is less than substantially 100:1 and more than substantially 5:1.

46. The chemical microreactor apparatus of claim 37 wherein said high aspect ratio is less than substantially 50:1 and more than substantially 5:1.

47. The chemical microreactor apparatus of claim 37 wherein said high aspect ratio is less than substantially 25:1 and more than substantially 5:1.

48. The chemical microreactor apparatus of claim 37 wherein said high aspect ratio is less than substantially 100:1 and more than substantially 15:1.

49. The chemical microreactor apparatus of claim 37 wherein said high aspect ratio is less than substantially 50:1 and more than substantially 15:1.

50. The chemical microreactor apparatus of claim 37 wherein said high aspect ratio is less than substantially 25:1 and more than substantially 15:1.
